(19) United States
(12) Patent Application Publication
(10) Pub. No.: US 2009/0195036 A1
(43) Pub. Date: Aug. 6, 2009

(54) Car Seat Pillow and Trolley Cushion

(76) Inventor: Rebecca Kathleen Timmis, New South Wales (AU)

Correspondence Address: LACKENBACH SIEGEL, LLP, LACKENBACH SIEGEL BUILDING, 1 CHASE ROAD, SCARSDALE, NY, 10583, US

(21) Appl. No.: 12/095,873

(22) PCT Filed: Nov. 30, 2006
(86) PCT No.: PCT/AU2006/001800

§ 371 Date: Aug. 27, 2008

(30) Foreign Application Priority Data
Dec. 1, 2005 (AU) 2005906726

(51) Int. Cl. A47D 1/10; B60N 2/48

(52) U.S. Cl. 297/256.17; 297/397

(57) ABSTRACT

A pillow for a children's car seat includes a first, a second, and an intermediate padded portion, and means for retaining the pillow on the car seat or a vehicle car seat on which the car seat is installed. The retaining means retains the pillow regardless of occupancy of the children's car seat. The retaining means may alternatively and adaptively take the form of: a flap depending from the top of the children's car seat so as to be trapped between the children's car seat and the vehicle car seat; and means to attach the pillow to a harness for the children's car seat on a seat belt of the vehicle car seat. Additionally, a cushion for a trolley or a cart which includes a seat, a backrest and apertures for the legs of an occupant. The cushion includes a seat, a backrest, a pair of leg, and means for retaining the cushion in the trolley.

### CROSS REFERENCE TO RELATED APPLICATIONS

This application claims priority from PCT/AU2006/001800 filed Nov. 30, 2006, the contents of which are incorporated herein fully by reference, and which in turn claims priority from AU Ser. No. 2005906726 filed Dec. 1, 2005.

### FIELD OF THE INVENTION

This invention is concerned with protection and comfort of babies and young children. In particular, the invention is concerned with a pillow, suitable for use with a car seat and with a cushion, suitable for use with a shopping cart or trolley.

### BACKGROUND OF THE INVENTION

It is common in many countries to require babies and young children to be transported in vehicles using an especially-designed car seat. For ease of reference, these car seats are referred to below as “children's car seats”.

Children's car seats are fastened to the vehicle, normally using especially-designed anchor points. Transportation of a child in a children's car seat is usually adequate while the child is awake. However, children frequently fall asleep during transportation in vehicles. Existing children's car seats do not provide adequate support for a child's head when asleep. As a result, in most cases the head of a sleeping child is not properly supported and falls sideways at an awkward angle. It is undesirable that a child's head is not properly supported in a children's car seat, when the child is asleep.

Inserting a conventional pillow behind the child's head is not a suitable solution, because such a pillow does not stay in place behind the child's head, but tends to slip down behind the child's back.

In addition, it is desirable that any support for the child's head is easy to remove quickly when not required.

### DISCLOSURE OF THE INVENTION

It is an object of the present invention, in a first aspect, to provide a pillow for use in connection with a children's car seat, which overcomes or substantially alleviates this problem.

Accordingly, in a first aspect, this invention provides a pillow for a children's car seat when installed on a vehicle car seat, the pillow adapted in use to support a child's head without the pillow lying behind the child's back, the pillow being divided into three portions:
a first rectangular padded portion;
a second rectangular padded portion;
a portion joining the first and second padded portions, with the pillow including means for retaining the pillow on a children's or vehicle's car seat.
wherein the retaining means is adapted to retain the pillow regardless of occupancy of the children's car seat and includes either:
a) a flap adapted to depend from the top of the children's car seat and to be trapped between the children's car seat and the vehicle car seat; or
b) means to attach the pillow to a harness for the children's car seat or a seat belt of the vehicle car seat, without requiring the harness or seat belt to traverse the first or second padded portions or the joining portion.

The pillow of the invention may be used with a variety of children's car seats, including with a car seat booster cushion.

The pillow of the invention may have a textile cover made of a material with a suitable degree of comfort for use by babies and young children. Cotton is an example of a suitable material. If desired, the part of the pillow of the invention which is not intended to contact the baby or child may be made of a different material, such as vinyl or any other suitable material.

The first and second padded portions are intended to be positioned on either side of the child's head when the pillow of the invention is in use. Consequently, it is preferred that the first and second padded portions have a relatively high level of padding, so as to provide the required level of cushioning to the child's head.

It is not intended that the pillow of the invention lies behind the back of the child to any significant extent, when the pillow is in use. However, to accommodate children of different heights, the pillow of the invention may be adjustable, especially via the retaining means.

Because most children's car seats have inclined sides in the region of the child's head, the first and second padded portions of the pillow of the invention will normally lie along the inclined sides, to embrace the head of the child in use.

The intermediate portion is preferably either lightly padded or has no padding, so that the child's head is not pushed forward within the car seat to any appreciable degree. Omission of padding on the intermediate portion may also enhance air circulation and help to prevent the child's head from becoming hot.

The means for retaining the pillow on the car seat may take various forms. Children's car seats are made in many variations. For example, some use “V” anchor harnesses and some use a central anchor harness, anchoring the children's car seat from the top. The car seat pillow of the invention may be specifically designed for a particular children's car seat or it may have a more general application.

For example, in one embodiment of the car seat pillow of the invention, the means for retaining the pillow on the car seat comprises a flap designed to depend from the top of the children's car seat, to be trapped between the children's car seat and the vehicle car seat. It will be appreciated, however, that this embodiment may not be suitable where the children's car seat is secured by a centre anchor strap or “V” anchor harnesses.

As another example, the retaining means may comprise ties which could attach the pillow to, for example, a harness for the car seat.

In an especially preferred embodiment, the retaining means of the car seat pillow of the invention has a pair of flaps and means to attach each flap to itself. Preferably, means are included to attach one flap to the other, in addition.

The attaching means may be of any suitable construction and include buttons and buttonholes, press-studs and hook and loop closures, such as those sold under the trade mark VELCRO. Other attaching means will be apparent to one skilled in the art and are within the scope of this invention.

When means are provided to attach one flap to the other, these means may be integral with one or each flap, or may be separate, being joined to the flaps by appropriate attaching means.

Preferably, the retaining means is of sufficient length to allow for adjustment of the first and second padded portions and the intermediate portion upwardly or downwardly in use, to adjust for different child heights.

It will be appreciated that the car seat pillow of the invention may enable the head of the child to be properly supported in a car seat, even when the child is asleep, and can prevent discomfort and possible injury to the child through improper posture while asleep.

In addition, the pillow of the invention may be designed so that it can be flipped upwardly when not in use, without the need to detach it from the car seat.

The second aspect of the invention is concerned with the transportation of babies and young children in supermarket carts or trolleys. Most supermarkets provide steel trolleys for use by customers. Many of these include an area in which a child or infant can sit during the shopping expedition. However, in most cases, the seat area in the supermarket trolley provides little or no degree of comfort to the child or infant and may even offer sharp edges or snags which may injure the infant or child.

It is an object of this invention, in the second aspect, to provide a cushion, for a cart or trolley of the type used in supermarkets and the like, which can overcome or substantially alleviate the situation described.

Accordingly, in a second aspect, this invention provides a cushion for a trolley or cart of the type which includes a seat, a backrest and apertures for the legs of an occupant, wherein the cushion includes a seat portion, a backrest portion, a pair of leg portions and means for retaining the cushion in the trolley.

The cushion of this second aspect of the invention may be made of any suitable material, preferably a textile material, such as cotton, which will be of a sufficient level of comfort for the child or infant who is to sit on it. Each of the portions of the cushion of the invention may be padded with suitable wadding, as desired. Each portion may be padded to a different extent from other portions, if desired. For example, the seat portion and the back portions may include more padding than the leg portions.

It will be appreciated that the cushion of the invention need not contain any padding at all, if it is made of a sufficiently robust and comfortable material.

The leg portions are preferably designed so that in use they pass through the apertures on the trolley or cart for the legs of an occupant and depend from those apertures. In this way, the leg portions may provide protection and comfort for the occupant's legs, to minimise the likelihood that the legs of the occupant will be injured by the trolley, even if the occupant were to swing the occupant's legs during the shopping expedition.

The retaining means may take any desirable form. Most conveniently, the retaining means is in two parts. The first part comprises a pair of straps, preferably located on either side of the backrest portion and close to the junction of the backrest and seat portions. Preferably, the straps can be secured to bars of the trolley or cart in a simple and efficient manner. In the preferred embodiment, each of the straps has a hook or loop strip which can mate with a corresponding loop or hook strip on the rear of the backrest, after wrapping round a convenient trolley bar.

The second part of the restraining means is preferably a flap or a pair of flaps attached to or extending from the top end of the backrest. Preferably, the flap or pair of flaps includes, on the rear, hook or loop fastener strips, which are intended to mate with corresponding loop or hook strips on the rear of the backrest. Hook and loop fasteners are preferred because they permit a certain amount of adjustment during fastening and thus enable the cushion of the invention to be used with different sizes or designs of trolleys or carts.

It will be appreciated that the cushion of the invention, especially in the form of the preferred embodiment, can be rolled into a relatively small package for transport to and from the supermarket. At the supermarket, it can be simply installed in a trolley or cart. It is even possible to install the cushion of the invention with one hand, leaving the other hand free to hold the infant or child. During the shopping expedition, the infant or child may be well protected from injury by the cushion of the invention, which also substantially increases the comfort of the infant or child installed in the trolley or cart.

Some supermarket trolleys or carts provide safety harnesses for children occupying the seat. It is preferred that the cushion of the invention is designed so that it does not interfere with the use of such safety harnesses.

### BRIEF DESCRIPTION OF THE DRAWINGS

The invention will now be described in connection with certain non-limiting embodiments thereof, in connection with the accompanying drawings, in which:

FIG. 1 is a plan view of a first embodiment of the pillow for a child's car seat according to the first aspect of the invention;

FIG. 2 is a plan view of a second embodiment of the car seat pillow according to the first aspect of the invention;

FIG. 3 shows the car seat pillow of FIG. 2 with the retaining means flap closed;

FIGS. 4 and 5 show in detail conversion of the FIG. 2 configuration of the pillow to that shown in FIG. 3;

FIG. 6 is a plan view of a third embodiment of the car seat pillow according to the first aspect of the invention;

FIG. 7 is a perspective view of the car seat pillow of FIG. 2, mounted on a car seat;

FIG. 8 shows the car seat pillow of FIG. 7 in use;

FIG. 9 is a front plan view of an embodiment of the cushion according to the second aspect of the invention;

FIG. 10 is a reverse plan view of the embodiment of FIG. 9;

FIG. 11 is a perspective view from in front of the embodiment of FIGS. 9 and 10 in place in a supermarket trolley;

FIG. 12 is a rear elevation view of the embodiment of FIGS. 9, 10 and 11, in use; and

FIG. 13 shows the car seat pillow of FIG. 2 in use in conjunction with a car seat booster cushion.

### DETAILED DESCRIPTION OF THE DRAWINGS

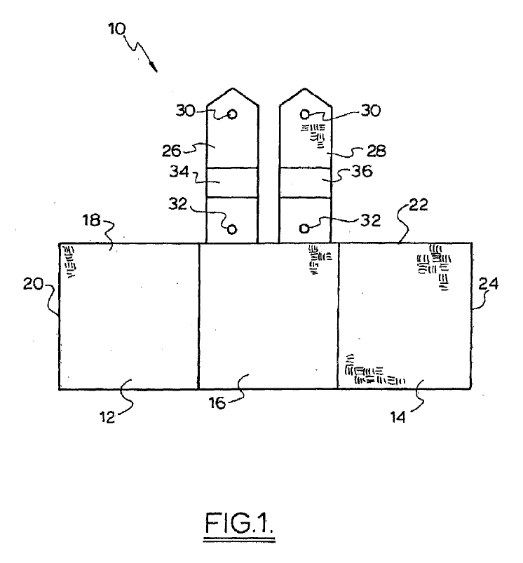

Turning first to the first embodiment illustrated in FIG. 1, pillow 10 has first padded portion 12 and second padded portion 14, each filled with appropriate wadding. First padded portion 12 and second padded portion 14 are separated by intermediate portion 16, which contains no filling. Pillow 10 is covered in a cotton fabric and optionally has piping around the perimeters indicated at 18, 20, 22 and 24.

In this embodiment, the retaining means takes the form of two flaps 26 and 28. Each flap 26 and 28 includes press studs 30 and 32. Each of flaps 26 and 28 may thus be folded over at fabric tabs 34 and 36 respectively. Flaps 26 and 28 can be inserted behind the child's car seat (not shown) to be retained by friction between the back of the car seat and the vehicle seat. Alternately, each flap 26 and 28 may be looped over a vehicle seat restraint (not shown) or other appropriate element and press stud 30 connected to press stud 32. In this way, pillow 10 may be secured to the vehicle or children's car seat. It is preferred that flaps 26 and 28 do not contain any filling. It is also preferred that intermediate portion 16 does not contain any filling.

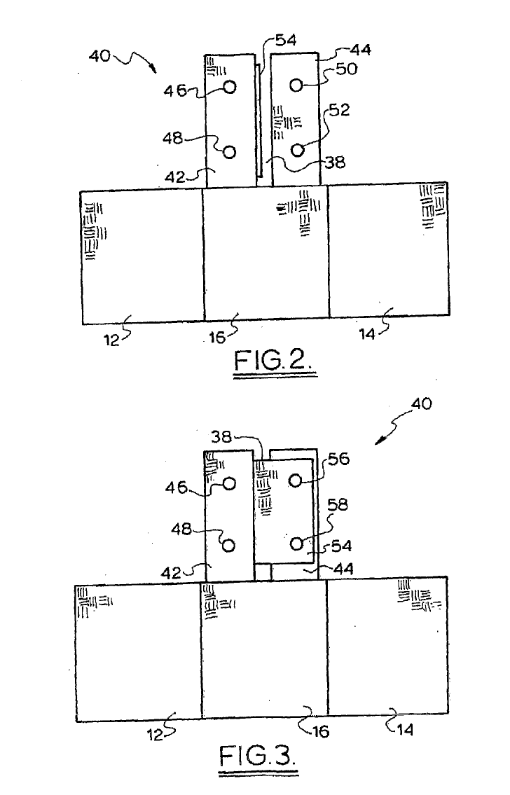

Turning now to the embodiment illustrated in FIGS. 2 to 5, the parts corresponding to the same parts as in the first embodiment will carry the same identifying numerals in the second embodiment. Pillow 40 has first padded portion 12 and second padded portion 14, separated by non-padded intermediate portion 16. Car seat pillow 40 can be adapted for use with car seats with a centre anchor harness (FIG. 2) or car seats with “V” anchor harnesses or booster seats (FIG. 3).

As can be seen in FIG. 2, flaps 42 and 44 have between them a centre space 38, which can accommodate a centre, anchor harness (not shown). Flap 42 has press studs 46 and 48, while flap 44 has press studs 50 and 52.

Behind flap 42 is a third flap 54, the edge of which can be seen in FIG. 2. This has press studs 56 and 58 (refer FIG. 3). When pillow 40 is in the configuration shown in FIG. 2, press studs 56 and 58 of flap 54 are connected to press studs 46 and 48 of flap 42.

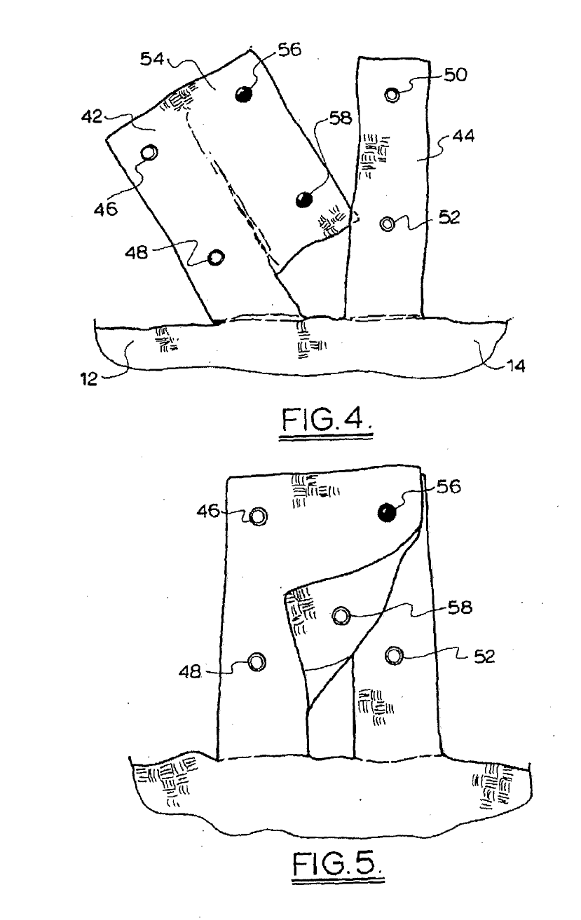

In order to convert pillow 40 for use with a booster seat or a vehicle which has “V” anchor harnesses for the car seat, press studs 56 and 58 are detached from press studs 46 and 48 and attached instead to press studs 50 and 52, as shown in FIG. 3. Refer also to FIGS. 4 and 5.

Although third flap 54 is shown as a separate piece in FIGS. 2 and 3, it may in fact consist of an extension of flap 42, as shown in FIGS. 4 and 5.

As will be apparent to one skilled in the art, press studs 46, 48, 50, 52, 56 and 58 may be replaced by other suitable closures, such as buttons and button holes, for example.

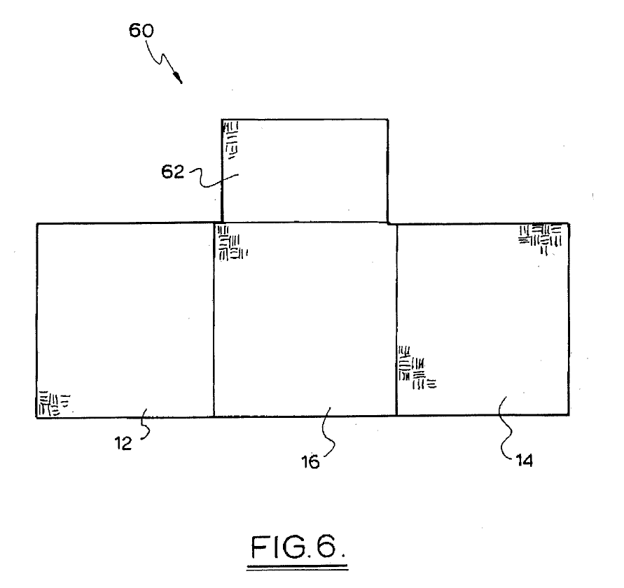

The third embodiment of the pillow of the invention shown in FIG. 6 represents a simple form of the pillow. In this embodiment, pillow 60 has first padded portion 12, second padded portion 14 and intermediate portion 16, as before. However, in this embodiment flap 62 is in a single piece and is made in a length sufficient to enable it to be trapped between a vehicle seat and the child's car seat (not shown).

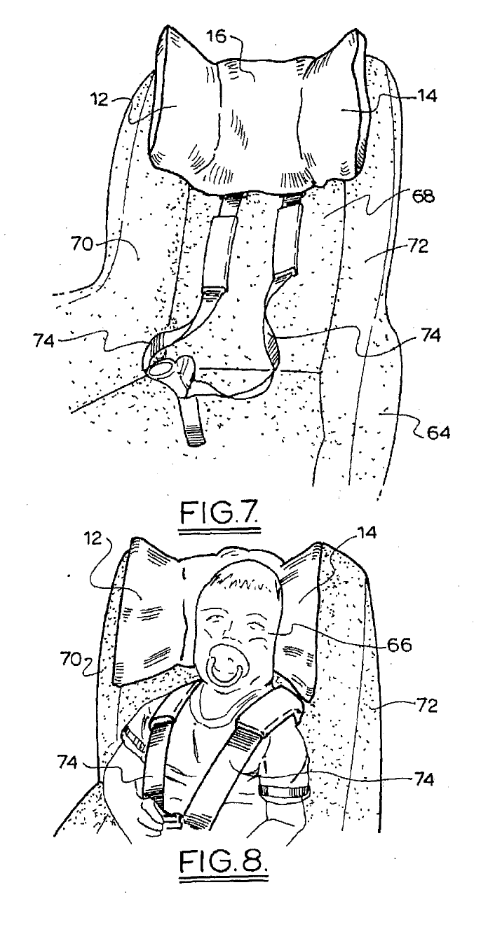

In FIGS. 7 and 8, the pillow of the invention is shown in situ attached to a child's car seat 64. As can be seen from these Figures, the pillow is held by flaps 42 and 44 (refer to FIG. 2) so that portions 12, 14 and 16 are located in the region of the child's head 66. Intermediate portion 16 fits neatly into the back 68 of child seat 64. Wings 70 and 72 of child seat 64 cause padded portions 12 and 14 to wrap around the child's head 66, so that the head 66 will be properly supported should the child fall asleep. Thus the child's comfort is optimized and danger of injury to the child's neck is minimized.

It will also be noted from FIGS. 7 and 8 that pillow 40 does not interfere with operation of the child restraint 74.

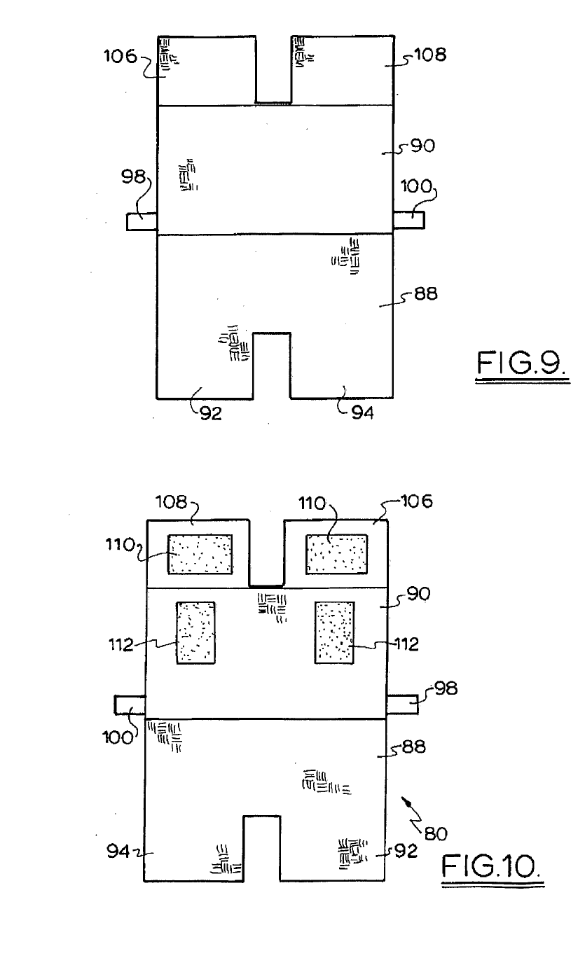

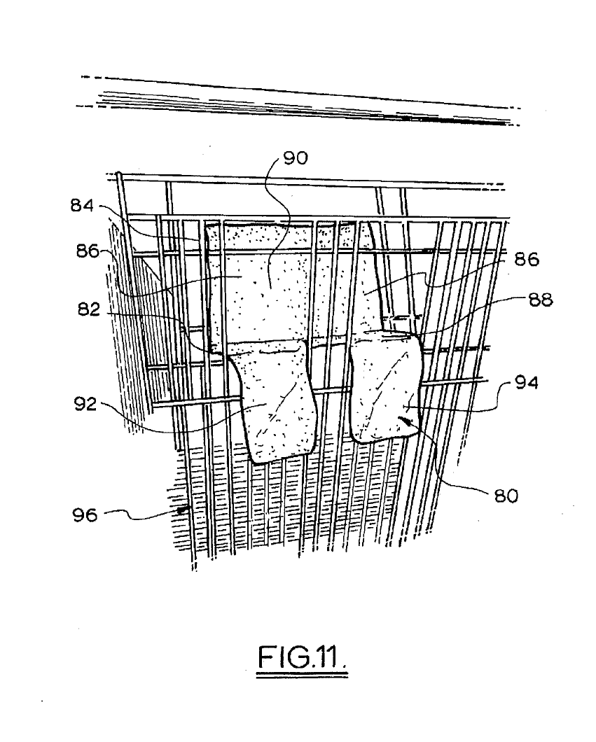

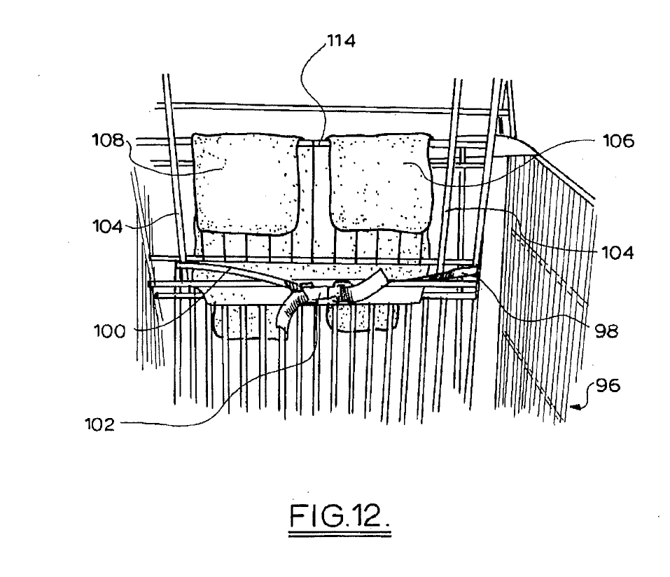

Reference is now made to the embodiment of the cushion for a trolley or cart, illustrated in FIGS. 9 to 12. In this embodiment, cushion 80 is intended for the type of trolley or cart 96 which has a seat, 82, a back rest 84 and apertures 86 for the legs of an occupant (not shown)—refer FIGS. 11 and 12.

Cushion 80 has seat portion 88, back rest portion 90 and a pair of leg portions 92 and 94. In this embodiment, leg portions 92 and 94 are in fact an extension of seat portion 88.

Cushion 80 also includes means for retaining cushion 80 in trolley 96. The retaining means is in two parts. The first part comprises straps 98 and 100. These are shown as relatively short in FIGS. 9 and 10. In this version straps 98 and 100 may be lined with a hook and loop fastener, so that they may be doubled over around a suitable bar on supermarket trolley 96. Alternately, straps 98 and 100 may be longer as shown in FIG. 12 and terminate in buckle closure 102. In this version, straps 98 and 100 are wrapped around bars 104 of trolley 96 (refer FIG. 12) and buckled together using buckle closure 102.

The second part of the restraining means includes flaps 106 and 108, attached to or forming an extension of backrest portion 90. As can be seen from FIG. 10, each of flaps 106 and 108 contains a length of hook and loop closure 110 which can mate with loop and hook closure 112 on the rear of backrest portion 90. Loop and hook closure 112 is deliberately oriented in a way which is perpendicular to that of hook and loop closure 110, to facilitate adjustment between them, to allow for different sizes of trolley backrests 84.

In this embodiment, seat portion 88, backrest portion 90 and leg portions 92 and 94 are lightly padded by suitable wadding.

Cushion 80 may be rolled into a cylinder or folded to a relatively small size for transport to the supermarket. It may then be unrolled or unfolded and attached to trolley 96 by laying seat portion 88 on trolley seat 82 and annexing backrest portion 90 to trolley backrest 84. Flaps 106 and 108 may then be flipped over trolley bar 114 and hook and loop closures 110 pressed into loop and hook closures 112. Leg portions 92 and 94 are then pulled through apertures 86.

At this stage, the infant or child (not shown) may be placed on seat portion 88 and the infant or child's legs inserted into apertures 86. The carer will then have two hands free to join straps 98 and 100 through buckle closure 102. Alternately, if cushion 80 has short straps with hook and loop closures (110, 112), the carer can attach these using one hand.

If trolley 96 includes child restraint straps, these may then be attached to the child, to restrain the child in trolley 96.

As can be seen particularly from FIG. 11, leg portions 92 and 94 provide cushioning and protection for a child's legs when a child is seated in cushion 80, while seat portion 88 and backrest portion 90 provide comfort and protection for the torso of the child.

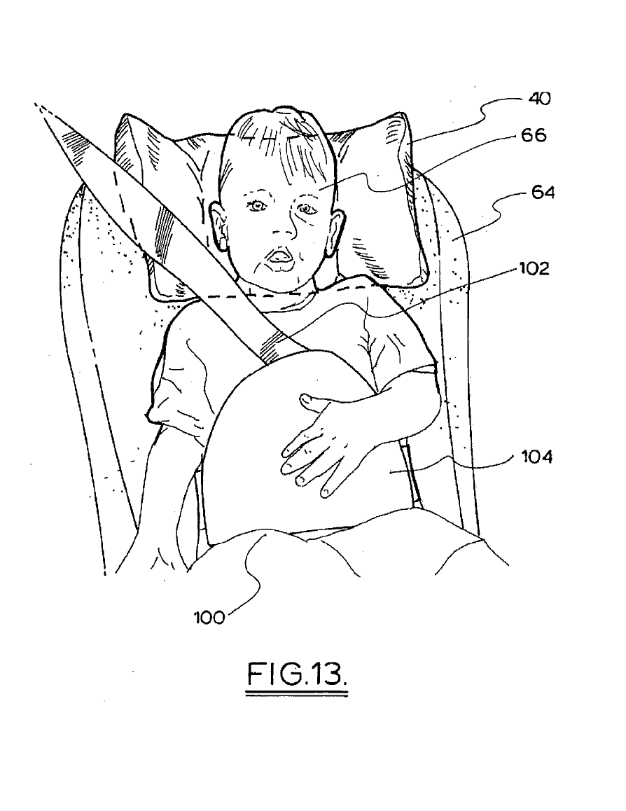

Referring now to FIG. 13, child seat 64 of FIGS. 7 and 8 has been modified by the addition of a booster cushion under child 100. Pillow 40 is attached to seat 64 in the same manner as described for FIGS. 7 and 8. Despite the elevation of child 100 by the booster cushion (not shown), pillow 40 still enables the child's head 66 to be supported in seat 64. Pillow 40 does not interfere with the operation of normal seat belt 102, which is shown here inserted into a child safety adaptor 104.

It will be apparent to one skilled in the art that various changes may be made to the embodiments disclosed herein without departing from the spirit and scope of the invention and that such changes are within the scope of the present invention.

### INDUSTRIAL APPLICABILITY

Many people use children's car seats or trolleys for transportation of their babies and children. The disclosed invention provides a pillow to support a child's head and alleviate the problem of the child's head being at an awkward angle, while sleeping. Further the invention discloses a cushion to improve the comfort and safety of a child when transported in a trolley.

The invention, therefore, provides a product which is likely to be of great benefit to parents and children around the world.

1.-25. (canceled)

26. A pillow for a children's car seat when installed on a vehicle car seat, the pillow adapted in use to support a child's head without the pillow lying behind the child's back, the pillow being divided into three portions, the pillow comprising:
a first rectangular padded portion; a second rectangular padded portion; and a portion joining the first and second padded portions, with the pillow including means for retaining the pillow on a children's or vehicle's car set, wherein the retaining means is adapted to retain the pillow regardless of occupancy of the children's car seat and includes at least one of:
a) a flap adapted to depend from the top of the children's car seat and to be trapped between the children's car seat and the vehicle car seat; and
b) means to attach the pillow to a harness for the children's car seat or a seat belt of the vehicle car seat, without requiring the harness or seat belt to traverse the first or second padded portions or the joining portion.

27. The pillow of claim 26, which has a textile cover made of a material with a suitable degree of comfort for use by babies and young children.

28. The pillow of claim 26, wherein: the first and second padded portions have a relatively high level of padding.

29. The pillow of claim 26, wherein: the joining portion is either lightly padded or has no padding.

30. The pillow of claim 26, wherein: the retaining means is a single flap.

31. The pillow of claim 26, wherein: the retaining means has ties adapted to attach the pillow to a harness for the children's car seat.

32. The pillow of claim 26, wherein: the retaining means has a pair of flaps and means to attach each flap to itself.

33. The pillow of claim 32, where the attaching means include at least one selected from the following group: buttons and buttonholes, press-studs, and hook and loop closures.

34. The pillow of claim 33, wherein the attaching means are at least one of a group comprising: being integral with one or each flap, being separate, and being joined to the flaps by other attaching means.

35. The pillow of claim 26, wherein the retaining means is adapted for adjustment of the first and second padded portions and the intermediate portion upwardly or downwardly, in use.

36. The pillow of claim 26, which is adapted to be flipped upwardly when not in use.

37. A cushion for a trolley or a cart of the type which includes a seat, backrest and apertures for the legs of an occupant, wherein: the cushion includes a seat portion, a backrest portion, a pair of leg portions and means for retaining the cushion in the trolley or cart.

38. The cushion of claim 37, which is made of a textile material.

39. The cushion of claim 37, wherein each of the portions is padded with wadding.

40. The cushion of claim 39, wherein each of the portions is padded to a different extent from other portions.

41. The cushion of claim 37, wherein the leg portions are adapted to pass through the apertures of the trolley or cart for the legs of the occupant.

42. The cushion of claim 37, wherein the retaining means includes two parts.

43. The cushion of claim 42, wherein: the first part of the retaining means includes a pair of straps located on either side of the backrest portion and close to the junction of the backrest and seat portions.

44. The cushion of claim 43, wherein: the straps are secured to bars of the trolley or cart.

45. The cushion of claim 44, wherein: each of the straps has a hook or loop strip adapted to mate with a corresponding loop or hook strip of the backrest, after wrapping round the bars.

46. The cushion of claim 42, wherein: the second part of the restraining means is a flap or a pair of flaps attached to or extending from the backrest.

47. The cushion of claim 46, wherein: the flap or pair of flaps includes hook or loop fastener strips adapted to mate with corresponding loop or hook strips of the backrest.

48. The cushion of claim 37, which is adapted to be rolled into a relatively small package.
